(19) United States
(12) Patent Application Publication
(10) Pub. No.: US 2011/0284198 A1
(43) Pub. Date: Nov. 24, 2011

(54) METHOD FOR JOINING COMPONENTS MADE OF A HIGH-STRENGTH ALUMINUM MATERIAL AND HEAT EXCHANGER ASSEMBLED ACCORDING TO THE METHOD

(75) Inventors: Hanskarl Hoffmann, Koln (DE); Rahul Rajagopalan, Regensburg (DE)

(73) Assignee: VISTEON GLOBAL TECHNOLOGIES, INC., Van Buren Twp., MI (US)

(21) Appl. No.: 13/183,523

(22) Filed: Jul. 15, 2011

Related U.S. Application Data
(63) Continuation of application No. 12/114,922, filed on May 5, 2008.

(30) Foreign Application Priority Data
May 11, 2007 (DE) 102007022632.4-24

(51) Int. Cl. F28F 7/00; B23P 15/26

(52) U.S. Cl. 165/185; 29/890.054

(57) ABSTRACT

The invention relates to a method for joining components made of a high-strength aluminum material, whereby at least two components of high-strength aluminum alloys are joined by soldering, both components separated from each other by at least one aluminum layer with a lower magnesium content compared with the contact surfaces before joining is carried out, and a heat exchanger produced according to this method.

### CROSS-REFERENCE TO RELATED APPLICATION

This application is a continuation of U.S. patent application Ser. No. 12/114,922 filed on May 5, 2008, which in turn claims priority to German Patent Application No. 10 2007 022 632.4-24, filed May 11, 2007. The entire disclosures of the above applications are hereby incorporated herein by reference.

### FIELD OF THE INVENTION

The invention relates to a method for joining components made of a high-strength aluminum material, and a heat exchanger assembled according to this method. Heat exchangers of this type can especially be used in air conditioning systems of motor vehicles. The method of the invention can also be applied in configuring other assemblies that are subject to requirements similar to those of heat exchangers, especially in motor vehicle air conditioning systems.

### BACKGROUND OF THE INVENTION

For various heat exchangers, certain configurations have become established, which are based essentially upon the fact that they contain a plurality of lines through which fluid flows. The lines are arranged closely side by side, which are connected to a collection tank and a distributor. The collection tank and the distributor can in turn be connected to a connecting block or connecting blocks, into which additional lines, such as inlet or outlet lines, and connecting means for integrating the heat exchanger into the overall system can open. Typical applications for heat exchangers structured in this manner are as condensers/gas coolers or evaporators in vehicle air conditioning systems. Use in the motor vehicle sector carries with it specific requirements. These include a small space requirement, high operational reliability and functional efficiency, environmental friendliness to an increasing extent, and low production expenditure.

In order to allow newer heat exchangers to operate using an environmentally friendly and effective coolant, especially one based upon carbon dioxide under high pressure, structural changes in relation to the prior art are necessary to be able to fulfill the growing static requirements and the allowances derived from these for the burst pressure of heat exchanger assemblies. Especially, parts having large cross-sections through which fluid flows and connection points between individual units that are exposed to the pressure of the fluid must be substantially more stable and/or sturdy in structure, while in the motor vehicle sector, high shock and vibration resistance is also necessary.

In this, one set of problems results from potentially major differences in the material masses of the parts to be connected. Therefore, the selection of the soldering or welding parameters required for a pressure-tight and fluid-tight connection can be critical. If a certain connection method, for example a soldering method such as a CAB method is prescribed, the requirements in terms of parameters to be adhered to can be further intensified.

In customary R134a systems, aluminum alloys of medium strength, such as alloys belonging to Aluminum Association Series 3xxx, are used for distributors and collecting tanks, and for inlet and outlet tubes. Connecting blocks made of high-strength 6xxx alloys are soldered to the distributor and the collecting tank, wherein a special fluxing agent, which contains cesium, is used. CAB furnace soldering is the method used, due to improved yields as compared with other methods and reduced maintenance requirements for the furnaces used. This method can be applied in the known manner to produce R134a components.

With the emergence of R744 systems, which are based upon the use of coolants under substantially higher pressures, stricter requirements in terms of the strength of the materials used and the strength at connection points between individual component parts result. For this reason, high-strength aluminum alloys are used for additional component parts such as the gas coolers, which correspond to the condenser in traditional R134a systems, and which can especially result in the requirement that contact surfaces of other components made of high-strength aluminum alloys must be connected to one another in a fluid-tight and burst-proof manner. Because the strength of aluminum alloys is significantly influenced, at least to some extent, by the magnesium content of the alloys, the relatively high magnesium concentrations of the high-strength alloys cause problems in cases of soldering in direct contact, because with customary soldering methods an increase in the magnesium concentration in the area of the soldered connection can occur, causing concentration levels that to some extent exceed the magnesium concentration in the alloy.

Especially when customary fluxing agents are used, increases in the magnesium concentration to levels above 0.3% will cause a decrease in the effectiveness of the fluxing agent. Therefore, a decrease in the quality and strength of the soldered connection is experienced since the fluxing agent is no longer able to fully break down oxide layers near the surface. To expose the metallic surfaces of the components to be connected for the best possible contact with the solder, a filler material may be required that can be fused on in the soldering process. The decrease in the effectiveness of the fluxing agent is partly caused by a contamination of the fluxing agent with released magnesium. This is why the magnesium content of both contact surfaces to be soldered together must be included in the calculation of the maximum allowable magnesium concentrations. The maximum levels indicated in the relevant literature should therefore be viewed as approximately the sum of the individual concentrations within the alloy areas that are in contact with one another and are to be soldered.

As is generally known, this problem of a magnesium concentration that is too high in the area of the solder gap can be corrected using special formulations and compositions for the fluxing agents used. Especially the admixture of cesium, as opposed to cesium-free fluxing agents, makes it possible to solder together aluminum alloys having higher total magnesium concentrations. The maximum tolerable sum of magnesium concentrations in this process amounts to approximately 0.8% (DE 100 44 454 A 1, U.S. Pat. No. 5,171,377).

This process has the disadvantage that the upper limit of 0.8% magnesium content as the sum of the concentrations in the alloy areas to be soldered is in part far exceeded when components, each made of high-strength aluminum alloys, for example of 6xxx compounds, are joined. In such cases, fluxing agents, whose effectiveness in the presence of magnesium has been increased by adding cesium, lose their ability to effectively prepare the surfaces to be joined for a complete wetting in a subsequent soldering process. In other words, if the sum of magnesium concentrations exceeds the level of approximately 0.8%, soldered connections created using such fluxing agents will also exhibit lower quality and insufficient strength.

### SUMMARY OF THE INVENTION

The invention aims at providing a possibility to be able to braze together several components each made of a high-strength aluminum alloy, particularly of 6xxx-alloys, in an economic brazing process, particularly CAB brazing, while in particular meeting the demands set on heating, ventilating, and air conditioning (HVAC) systems in motor vehicles.

The method according to the invention enables two components made of high-strength aluminum materials, each of them having a magnesium concentration of up to 0.8%, to be joined together by CAB-brazing when an aluminum layer with little or no magnesium proportion is inserted between both contact surfaces to be brazed together. Hereby, the inserted aluminum layer ensures that the contact surfaces to be brazed together do not touch. Rather, the connection is realized over a mediating structure created by using two separate brazing joint clearances while, in each clearance, the magnesium concentration only rises to a level not higher than 0.8%. This makes it possible to perform a CAB process using traditional cesium-containing fluxes. It was surprisingly found that joining of components made of high-strength aluminum materials can be achieved, provided the contact surfaces extend sufficiently wide, also with mediating the joining through a lower-strength layer, such as lower-alloyed aluminum, without strength losses of the whole assembly. This is particularly the case if the area of the joint is established such that it is essentially subjected to shear and/or compression. Such an establishment of the area of the joint between the individual components of a whole assembly is present, for example, in most heat exchangers in HVAC systems, also in HVAC systems for motor vehicles.

Because high-strength aluminum alloys are thus made usable for components, for equal requirements for strength of the components, the wall thicknesses can clearly be chosen thinner, and thus, weight and outer dimensions of the components reduced.

Particularly, the invention consists in a method for joining components each made of high-strength aluminum material, where at least two components made of high-strength magnesium-containing aluminum alloys are joined by brazing, whereby the contact surfaces to be brazed together are separated from each other by an aluminum layer with little or no magnesium proportion compared with the materials of the contact surfaces, before the joining by a brazing material occurs. Separation as defined by the invention is meant to be the reliable avoidance of direct contact of the contact surfaces as well as the avoidance that a direct brazing material joint, on both sides limited by the contact surfaces, happens. Contact surfaces as defined by the invention are meant to be those areas, closest to the brazing joint clearance, of the components to be brazed together that consist of the high-strength magnesium-containing aluminum alloys, not including layers of lower strength and/or different composition possibly applied to the surfaces.

When the method according to the invention is carried out, it is irrelevant in what way the placement of the aluminum layer with little or no magnesium content compared with the components made of high-strength magnesium-containing aluminum alloys is realized. Advantageously, the contact surfaces to be brazed together can be separated before placing the brazing material by applying an aluminum layer with little or no magnesium content compared with the contact surfaces to at least one of the contact surfaces to be brazed together. Alternatively, both contact surfaces to be brazed together may be prepared for brazing by applying an aluminum layer with little or no magnesium content. When the respective components are jointed in order to be joined together by brazing, due to the layer previously applied to at least one side of the brazing joint clearance, the separation according to the invention of the contact surfaces made of the materials with the magnesium concentrations critical for traditional brazing methods develops automatically.

According to an advantageous alternative, the separation of the contact surfaces to be brazed together may be achieved by applying at least one aluminum layer made of a 1xxx- or 3xxx-alloy with little or no magnesium content compared with the contact surfaces to at least one of the contact surfaces to be brazed together. The brazing material may be fed in form of a paste or in form of rings of brazing material at the edge of the brazing joint clearance, or into the brazing joint clearance.

In the simplest case, the brazing material in form of brazing paste, brazing wire, or brazing rings is positioned by placing it onto the brazing joint clearance. An especially sound, high-quality brazed joint can be produced when, prior to brazing and after corresponding establishment or preparation of the brazing joint clearance, the brazing material is arranged partly or completely fixed in the brazing joint clearance. This can, for example, be achieved by filling the brazing joint clearance before the brazing operation by spreading a brazing paste on at least one component to be brazed before joining the components together. In other advantageous embodiments, appropriate recesses are provided in the components to be brazed together or in the formed parts to be placed in the brazing joint clearance according to the invention, serving to take the brazing material in form of brazing wire or brazing rings, so that already by loose joining of the components, the brazing material is fixed in its position to a great extent. Fixing the brazing material prior to the brazing operation leads to a particularly homogeneous and defined spreading of the brazing material into the brazing joint clearances, hence to a homogeneous wetting and particularly robust brazed joint.

In a further advantageous embodiment of the process according to the invention, the separation of the contact surfaces to be brazed together is carried out by inserting a formed part into a brazing joint clearance. The formed part at least partly, especially in the area of its surface, made of aluminum with little or no magnesium content compared with the contact surfaces. This divides the brazing joint clearance into two separate brazing joint clearances, in each of which after the brazing material has been placed the magnesium concentration will not exceed the level of 0.8%, whereby the magnesium concentration in the material the contact surfaces are made of, when a cesium containing flux is used, may absolutely be as high as 0.8%. Such formed parts can be provided with a formed part body of aluminum with little or no magnesium content compared with the contact surfaces, the formed part body being coated with an aluminum material different from that of the formed part body, also with little or no magnesium content compared with the contact surfaces and/or a layer of brazing material. When the brazing material is provided in a different way, the formed part body can also be used without any coating, whereby the formed part body defines the outer contour of the formed part.

It is desirable for the aluminum layer with little or no magnesium proportion to have a minimum layer thickness of 0.01 mm. For a particularly reliable processing, the layer thickness may be chosen larger. It is irrelevant whether the layer thickness with little or no magnesium is applied in one or several coating steps, for example, by plasma-aided vapour deposition or by one-side or double-side brazing material plating to at least one of the components to be joined, or is prepared in the form of a multiple-layered formed part to be inserted into the brazing joint clearance.

It is an advantage that for separating the contact surfaces to be brazed together, at least one layer of aluminum from the series 3xxx or 1xxx is used, which also may be plated with brazing material. By that, the maximum magnesium content to be expected in the area of the brazing joint clearance can be easily set based on a corresponding selection of readily available materials. This approach enables that the components are not restricted to low-magnesium materials, which would imply reduced strength. Rather, it will be easy to tune the maximum allowable magnesium content and the flux used to each other. For the separation according to the invention of the contact surfaces of the components to be brazed together made of high-strength aluminum material, combinations of aluminum layers with little or no magnesium (e.g., 3xxx or 1xxx), coated with brazing material on one or both sides (e.g., 4xxx), proved to be suitable material combinations in double layers. Instead of the brazing material coating, also a brazing paste or a brazing wire/ring may be used.

This invention makes possible, particularly with regard to applications in the automotive field, the joining of a high-strength distributor/collecting container of a heat exchanger made of an aluminum material of the 6xxx-series and/or of an inlet or outlet tube made of similar or equal material by brazing, particularly CAB brazing, to a connection block also made of a high-strength aluminum material of the 6xxx-series. Thus, the method according to the invention extends the field of application of CAB brazing to joining of components each made of high-strength aluminum alloys, whereby the sum of the magnesium concentrations in the areas to be brazed together of the contact surfaces can be raised up to about 1.6%, which amounts to doubling compared with prior art. Alternatively, the method according to the invention can also be used as flame brazing process with a corrosive or non-corrosive flux.

### BRIEF DESCRIPTION OF THE DRAWINGS

The invention is explained in greater detail by examples of embodiment. The accompanying drawings show:

FIG. 1 is an exploded perspective view of a heat exchanger established according to the invention, before final assembly by a brazed joint according to the invention;

FIG. 2 is a fragmentary section view through two components of high-strength aluminum joined to each other according to the invention;

FIG. 3 is an exploded view of the components, partially in section, for making a brazed joint according to the invention including a formed part;

FIG. 4 is a brazing joint clearance established according to the invention with a coating of brazing material, prepared for brazing;

FIG. 5 is a brazing joint clearance established according to the invention with brazing paste fed into the brazing joint clearance, prepared for brazing;

FIGS. 6a and 6b are a brazing joint clearance established according to the invention, FIG. 6a shows recesses established on the top of the components to be brazed together for taking the brazing material, and FIG. 6b shows recesses arranged in the central area of the components to be brazed together for taking the brazing material;

FIGS. 7a and 7b are a brazing joint clearance established according to the invention with an inserted formed part provided with recesses for taking the brazing material.

### DETAILED DESCRIPTION OF EXEMPLARY EMBODIMENTS OF THE INVENTION

The following description is merely exemplary in nature and is not intended to limit the present disclosure, application, or uses. It should also be understood that throughout the drawings, corresponding reference numerals indicate like or corresponding parts and features. In respect of the methods disclosed, the steps presented are exemplary in nature, and thus, are not necessary or critical.

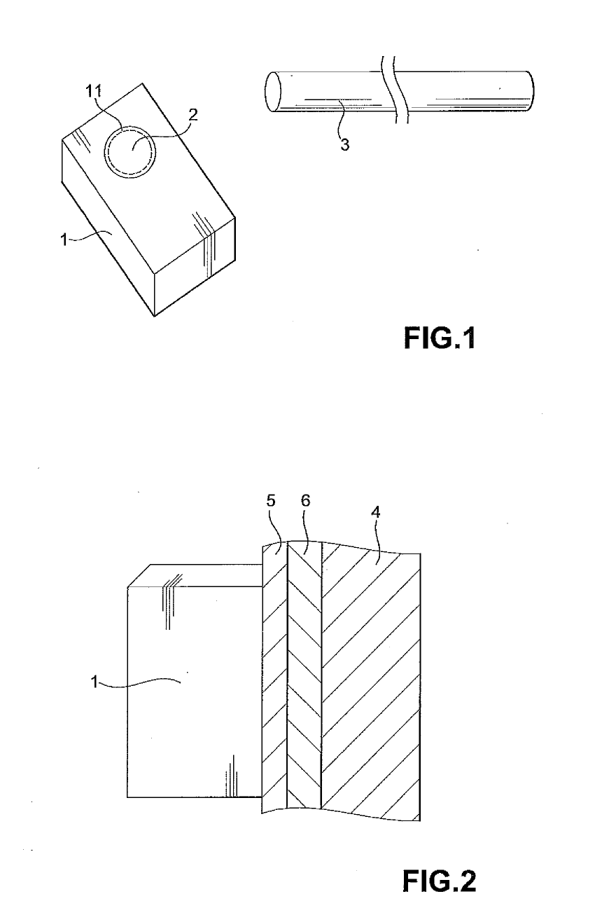

FIG. 1 shows a portion of a heat exchanger structured according to the invention, prior to final assembly via a solder connection according to the invention. Schematically depicted is a solid aluminum block 1 with a cylindrical depression 2, in which an aluminum tube 3 is to be soldered. As used herein, soldering includes other joining methods such as brazing, for example. In terms of heat exchangers for motor vehicle air conditioning systems, the aluminum block 1 embodies a connecting block, and the aluminum tube 3 an inlet tube. In the embodiment shown, the two components 1, 3 are made of a high-strength aluminum alloy containing magnesium, in this case a 6xxx material, and are to be soldered indirectly to one another to produce the required quality using a known fluxing agent containing cesium. By correspondingly structuring and/or dimensioning the contact areas of the two components 1, 3, in which the soldering is to take place, areas 11 can be provided, which enable accommodation according to the invention of at least one separation layer made of an aluminum material, which has a low magnesium concentration as compared with the components 1, 3 made of high-strength aluminum material, or no magnesium concentration, in the area of a remaining solder gap. The connection of the two components 1, 3 made of high-strength aluminum materials is accomplished with adequate extension of the contact surfaces and without impairment to the strength of the overall assembly, despite the creation of the connection according to the invention via the layer of lower strength and low or no magnesium concentration, because the area of connection is configured by the aluminum tube 3 that can be inserted into the cylindrical depression 2 such that after soldering it is substantially exposed to shear and/or pressure.

FIG. 2 shows two components 1, 4 made of high-strength aluminum, and connected to one another according to the invention, wherein the connection is implemented in the form of a flat solder via CAB soldering. An aluminum block 1 as a connecting block is soldered to a wall section of a distributor tube 4, wherein two separation layers 5, 6 having different magnesium concentrations, lower than that of the high-strength material of the 6xxx series, are positioned between the two components 1, 4, which are again made of high-strength aluminum material of the 6xxx series. The present case involves an aluminum layer 5 made of the 4xxx series, and an aluminum layer 6 made of the 3xxx series or 1xxx series. The two layers 5, 6 are applied to the distributor tube 4 prior to soldering of the components 1 and 4. Alternatively, a layer of the 1xxx or 3xxx series can be applied to the aluminum block 1, while the distributor tube is coated with material from the 4xxx series.

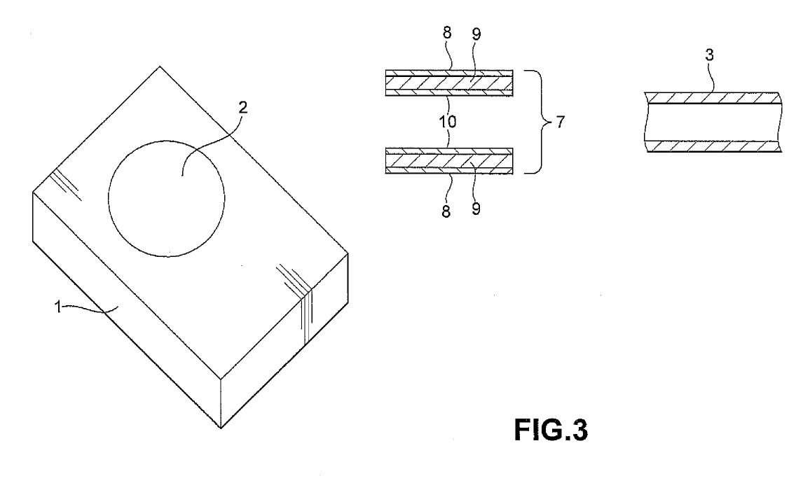

FIG. 3 shows an arrangement of the individual parts for implementation of a solder connection to a molded part according to the invention. Analogous to FIG. 1, the configuration includes a solid aluminum block 1 with a cylindrical depression 2, in which an aluminum tube 3 is to be soldered. Both are made of high-strength aluminum alloys of the 6xxx series. Also shown is a hollow, cylindrical molded part 7, which is made of an aluminum alloy of lower strength (1xxx or 3xxx), in other words of aluminum having a low or no magnesium content, which can be used between the aluminum pipe 3 and the wall of the cylindrical depression 2 to separate the two components before soldering takes place. To this end, the outer diameter of the hollow cylindrical molded part 7 is slightly smaller than the inner diameter of the cylindrical depression 2, and the inner diameter of the hollow cylindrical molded part 7 is slightly larger than the outer diameter of the aluminum pipe 3. It is thereby ensured that the individual parts can be easily joined one inside the other with play, and two solder gaps will remain. As the corresponding differences in diameter, values that will result in solder gap widths of 0.02 mm to 0.3 mm have proven beneficial. For the implementation of the process of the invention, it is advantageous for both surfaces of the hollow cylindrical molded part 7 to be wetted in advance with a fluxing agent containing cesium, in order to enable rapid and reliable soldering in a subsequent soldering process step by filling both solder gaps with a solder.

In the present example, the hollow cylindrical molded part 7 consists of a molded body 9 made of aluminum having a low or no magnesium content, with a solder coating 8, 10 on both sides. In this case, the solder gap widths can lie between 0.0 mm (transition fit) and 0.3 mm (play fit), whereby the area that is magnesium-poor according to the invention can be held very close against the contact surfaces of the components 1, 3 to be joined.

Hereinafter, solder gaps structured according to the invention will be presented without discussion of the structure of the components 1 and 3 to be joined, each of which is made of a high-strength aluminum alloy (6xxx). Using a molded part 7, which is made of an aluminum alloy of lower strength (1xxx or 3xxx), the solder gaps according to the invention are structured as solder gap pairs. These can be prepared for the soldering process in a different, advantageous manner. Various preparation measures can also be combined with one another. For example, a solder coating of the molded part 7 can be supplemented by an additional supply of solder, for example at the edge of the solder gap. In this manner, prepared, uniformly solder-coated molded parts can be adjusted to different solder gap widths. In what follows, the effect of various external contours of a molded part 7 of the invention will be essentially specified.

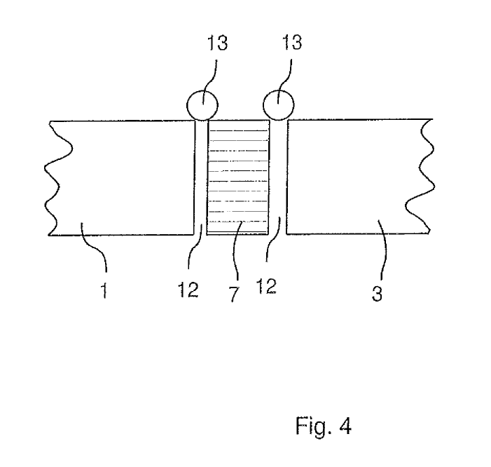

FIG. 4 shows a solder gap pair according to the invention, with solder wires 13 positioned on an upper edge of the solder gap 12, which can also be configured as solder rings. In this manner, a stabilization of the position of the prepared solder can be achieved, without fully fixing it in place. During the soldering process, the solder is melted, and flows into the solder gap 12, wherein the contact surfaces are fully wetted, and, after cooling, a firm and uniform soldered connection between the components 1, 3 results.

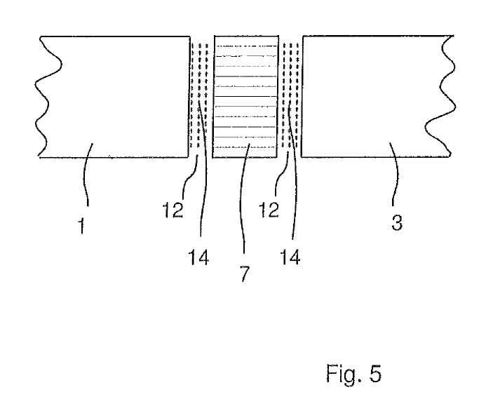

In FIG. 5, a solder gap pair structured according to the invention is shown, with solder paste 14 placed in the solder gap 12 in preparation for soldering. This can be accomplished through a corresponding preparation of the molded part 7, which includes at least in part of an aluminum alloy of lower strength (1xxx or 3xxx), if it is coated with solder paste prior to insertion into the connection area between the components 1, 3. In contrast, the contact surfaces of the components 1, 3 can be coated with solder paste before the molded part 7 is placed in the connection area. With this variant, the solder paste 14 and the inserted molded part 7 are fixed in position by virtue of the adhesive property of the solder paste 14. In such a case in which solder paste is used, a separate solder coating of the molded part 7 in advance can be dispensed with if a quantity of solder sufficient to fill the solder gap or gaps is provided by the solder paste.

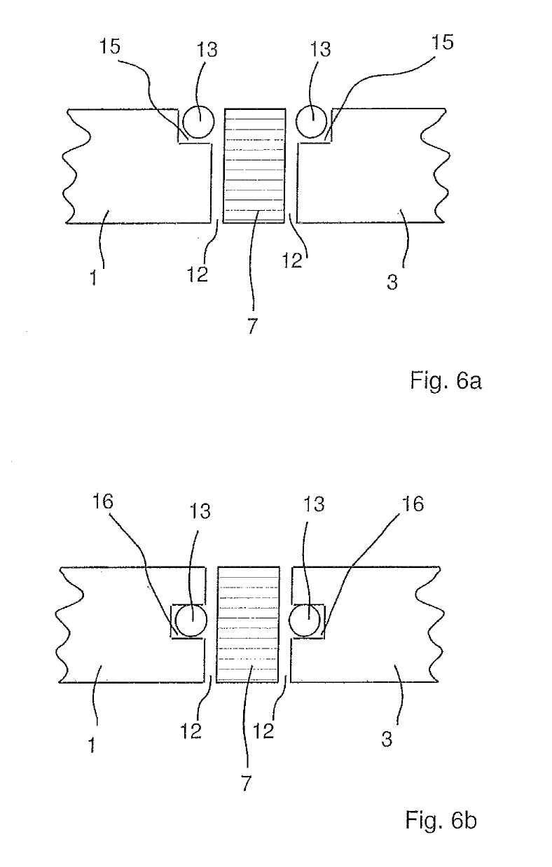

FIG. 6a shows a solder gap pair 12 structured according to the invention with recesses 15 formed on the upper side of the components 1, 3 to be soldered, intended to accommodate the solder in the form of solder rings 13. This allows a preassembly that is easily performed prior to fixing the components 1, 3 in place through the actual soldering process.

FIG. 6b shows a solder gap pair 12 structured according to the invention, with recesses 16 positioned in the center area of the components 1, 3 to be soldered, intended to accommodate the solder in the form of solder rings 13. This allows a preassembly that is easily performed prior to fixing the components 1, 3 in place through the actual soldering process, wherein a full immobilization of the solder rings 13 is achieved independently of the orientation of the components 1, 3 to be joined, which benefits a particularly uniform structure of the solder connection and good reproducibility.

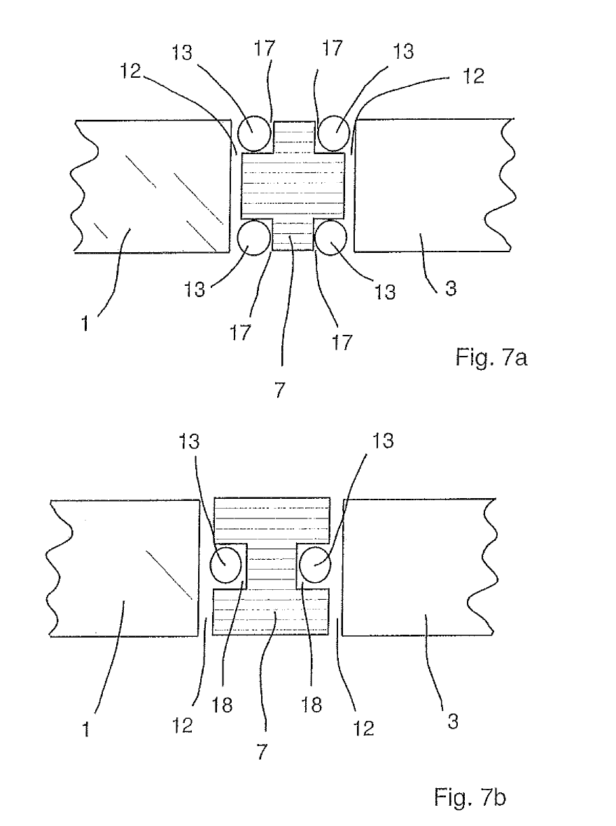

FIG. 7a shows a solder gap pair 12 structured according to the invention with an inserted molded part 7, which is made at least in part of an aluminum alloy of lower strength (1xxx or 3xxx), with recesses 17 intended to accommodate the solder in the form of solder rings 13, wherein the recesses 17 are positioned near the edge of the molded part 7. The advantage of an embodiment of this type is that no processing steps need to be performed on the actual components 1, 3, which are to be connected to one another via soldering, in order to accommodate or pre-fasten the solder rings 13.

FIG. 7b shows a solder gap pair 12 structured according to the invention with an inserted molded part 7, which is made at least in part of an aluminum alloy of lower strength (1xxx or 3xxx), with recesses 18 intended to accommodate the solder in the form of solder rings 13, wherein the recesses are positioned in the central area of the contact surfaces between the molded part 7 and the components 1, 3 to be soldered. A configuration of this type also offers the advantage of a complete immobilization of the solder rings 13, while leaving the components to be soldered unaffected up to the actual soldering step.

From the foregoing description, one ordinarily skilled in the art can easily ascertain the essential characteristics of this invention and, without departing from the spirit and scope thereof, can make various changes and modifications to the invention to adapt it to various usages and conditions in accordance with the scope of the appended claims.

### NOMENCLATURE

1 Aluminum block
2 Cylindrical depression
3 Aluminum tube
4 Distributor tube
5 Separation layer (solder)
6 Separation layer
7 Molded part
8 Solder coating
9 Molded body with low or no magnesium content
10 Solder coating
11 Areas
12 Solder gap
13 Solder ring
14 Solder paste
15 Recess on upper side of component
16 Recess in central area of contact surfaces of components
17 Recess on edge of molded part
18 Recess in central area of contact surfaces of molded part

What is claimed is:

1. A heat exchanger comprising:
a first heat exchanger component produced from a high strength aluminum alloy containing magnesium in a concentration of up to 0.8%;
a second heat exchanger component produced from a high strength aluminum alloy containing magnesium in a concentration of up to 0.8%; and
a solder connection disposed between the first heat exchanger component and the second heat exchanger component, the solder connection including a molded part produced at least partially of an aluminum alloy containing one of no magnesium and a lower magnesium content than the first heat exchanger component and the second heat exchanger component, and a pair of solder clearances with a brazing material disposed therein, each of the solder clearances formed between the molded part and one of the first heat exchanger and the second heat exchanger,
wherein a magnesium concentration in each of the solder clearances does not exceed 0.8%.

2. The heat exchanger according to claim 1, wherein the first heat exchanger component is one of a collection tank, a connecting block, a distributor tube, and a distributor, and the second heat exchanger component is one of a collection tank, a connecting block, a distributor tube, and a distributor.

3. The heat exchanger according to claim 1, wherein the molded part has a plurality of aluminum layers.

4. The heat exchanger according to claim 3, wherein the molded part is formed from at least one of a 4xxx, a 3xxx, and a 1xxx alloy and each of the first heat exchanger component and the second heat exchanger component is formed from a 6xxx alloy.

5. The heat exchanger according to claim 1, wherein a sum of the concentration of magnesium in the first heat exchanger component and the second heat exchanger component is up to about 1.6%.

6. The heat exchanger according to claim 1, wherein the molded part is plated with the brazing material.

7. The heat exchanger according to claim 1, wherein the brazing material is provided by at least one of a brazing material coating, a brazing paste, a brazing wire, and a brazing ring.

8. The heat exchanger according to claim 1, wherein the molded part includes at least one recess for accommodating the brazing material.

9. A method of joining heat exchanger components, the method comprising the steps of:
(a) providing a first heat exchanger component and a second heat exchanger component, each of the first heat exchanger component and the second heat exchanger component made of a high strength aluminum alloy containing magnesium in a concentration of up to 0.8%;
(b) placing between the first heat exchanger component and the second heat exchanger component a molded part produced at least partially of an aluminum alloy containing one of no magnesium and a lower magnesium content than the first heat exchanger component and the second heat exchanger component, a solder clearance formed between the molded part and each of the first heat exchanger and the second heat exchanger;
(c) disposing a brazing material into the solder clearances, wherein a magnesium concentration in each of the solder clearances does not exceed 0.8%; and
(d) soldering the first heat exchanger component and the second heat exchanger component to the molded part to connect the components.

10. The method according to claim 9, wherein step (d) includes soldering the first heat exchanger component and the second heat exchanger component to the molded part using one of a controlled atmosphere brazing technique and flame soldering with one of a corrosive and non-corrosive fluxing agent.

11. The method according to claim 9, wherein step (d) includes soldering the first heat exchanger component and the second heat exchanger component to the molded part using a controlled atmosphere brazing technique with a fluxing agent that contains cesium.

12. The method according to claim 9, wherein the brazing material is one of a paste, a wire, and a ring.

13. The method according to claim 9, further comprising the step of inserting the brazing material into each of the solder clearances.

14. The method according to claim 9, wherein the molded part separates the first heat exchanger component from the second heat exchanger component.

15. The method according to claim 9, wherein the molded part has at least one aluminum layer with at least one of a 4xxx, a 3xxx, and a 1xxx alloy.
